(19) United States
(12) Patent Application Publication
(10) Pub. No.: US 2016/0192336 A1
(43) Pub. Date: Jun. 30, 2016

(54) METHOD AND APPARATUS FOR TRANSMITTING DOWNLINK CONTROL INFORMATION IN MOBILE COMMUNICATION SYSTEM

(71) Applicant: Electronics and Telecommunications Research Institute, Daejeon (KR)

(72) Inventors: Eun-Young CHOI, Daejeon (KR); Juho PARK, Daejeon (KR); Young Seog SONG, Daejeon (KR); Jun Hwan LEE, Seoul (KR); Young Jo KO, Daejeon (KR); Seung Chan BANG, Daejeon (KR)

(21) Appl. No.: 14/984,288

(22) Filed: Dec. 30, 2015

(30) Foreign Application Priority Data
Dec. 30, 2014 (KR) 10-2014-0194142
Dec. 24, 2015 (KR) 10-2015-0186188

(51) Int. Cl. H04W 72/04; H04B 7/04

(52) U.S. Cl. CPC H04W 72/042; H04B 7/0408

(57) ABSTRACT

A method for transmitting downlink control information in a base station that operates a plurality of beams in one cell includes: configuring an individual control channel region allocated to each of the plurality of beams; configuring a shared control channel region shared with first and second beams that are adjacent to each other among the plurality of beams; allocating a control channel of a terminal positioned in a service coverage of the first beam to one of an individual control channel region of the first beam and the shared control channel region shared with the first and second beams; and in a case where the control channel of the terminal is allocated to the shared control channel region shared with the first and second beams, forming the first and second beams such that user control information of the terminal is transmitted through the shared control channel region shared with the first and second beams.

### CROSS-REFERENCE TO RELATED APPLICATION

This application claims priority to and the benefit of Korean Patent Application Nos. 10-2014-0194142, and 10-2015-0186188 filed in the Korean Intellectual Property Office on Dec. 30, 2014, and Dec. 24, 2015, the entire contents of which are incorporated herein by reference.

### BACKGROUND OF THE INVENTION

(a) Field of the Invention

The present invention relates to a method and apparatus for transmitting downlink control information in a mobile communication system, and more particularly, to a method and apparatus for transmitting downlink control information in a millimeter-wave-based mobile communication system using multiple beams.

(b) Description of the Related Art

Discovery of a new frequency domain is desperately required so as to secure a wideband frequency according to recently increasing traffic capacity.

Since a millimeter wave band may cover a wide frequency bandwidth in the range from 30 GHz to 300 GHz, it has been recently spotlighted as a 5G candidate frequency band worldwide. The millimeter-wave-based mobile communication system may use a wide frequency bandwidth, but it has a large path loss in a data transfer process due to a frequency characteristic having very strong straightness, and accordingly tends to have high radio wave attenuation. To minimize the path loss caused by using the millimeter wave band, a beam forming technology of identifying each of regions in a cell through beams has emerged as a very important technical factor. Beam forming has an effect of not only increasing signal intensity of a specific direction but also reducing signal transmission in an unwanted direction.

The beam forming technology has a merit of increasing transmission capacity in proportion to the number of beam, but it has a drawback of causing performance attenuation due to interference between adjacent beams.

Performance of a control channel in a mobile communication system greatly influences not only restoration performance of a traffic channel, but also performance of an entire system. Therefore, there is a need for a resource layout that avoids interference with respect to the control channel as much as possible when the beam forming technology is applied.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and apparatus for transmitting downlink control information having advantages of minimizing interference with respect to a control channel in a millimeter-wave-based mobile communication system.

An exemplary embodiment of the present invention provides a method for transmitting downlink control information in a base station that operates a plurality of beams in one cell, the method including: configuring an individual control channel region allocated to each of the plurality of beams; configuring a shared control channel region shared with first and second beams that are adjacent to each other among the plurality of beams; allocating a control channel of a terminal positioned in a service coverage of the first beam to one of an individual control channel region of the first beam and the shared control channel region shared with the first and second beams; and in a case where the control channel of the terminal is allocated to the shared control channel region shared with the first and second beams, forming the first and second beams such that user control information of the terminal is transmitted through the shared control channel region shared with the first and second beams.

Another embodiment of the present invention provides a method for transmitting downlink control information in a base station that operates a plurality of beams in one cell, the method including: configuring an individual control channel region allocated to each of the plurality of beams; configuring a shared control channel region shared with beams adjacent to each of the plurality of beams; determining a first beam among the plurality of beams as a main transmission beam of a terminal; acquiring interference intensity of a second beam adjacent to the first beam with respect to the terminal; in a case where the interference intensity exceeds a threshold, preferentially allocating a control channel of the terminal to a shared control channel region of the first and second beams; and when the control channel of the terminal is allocated to the shared control channel region of the first and second beams, forming the first and second beams such that user control information of the terminal is transmitted through the shared control channel region of the first and second beams.

Yet another embodiment of the present invention provides an apparatus for transmitting downlink control information in a mobile communication system that operates a plurality of beams in one cell, the apparatus including: a transceiver transmitting/receiving the plurality of beams including first and second beams that are adjacent to each other; and a processor configuring an individual control channel region allocated to each of the plurality of beams and a shared control channel region shared with first and second beams that are adjacent to each other among the plurality of beams, allocating a control channel of a terminal positioned in a service coverage of the first beam to one of an individual control channel region of the first beam and the shared control channel region shared with the first and second beams, and in a case where the control channel of the terminal is allocated to the shared control channel region shared with the first and second beams, forming the first and second beams such that user control information of the terminal is transmitted through the shared control channel region shared with the first and second beams.

### BRIEF DESCRIPTION OF THE DRAWINGS

FIG. 1 is a view showing a millimeter-wave-based mobile communication system according to an exemplary embodiment of the present invention.

FIG. 2 is a view for describing interference between beams in a case where multiple beams operate in one cell in a mobile communication system according to an exemplary embodiment of the present invention.

FIG. 3 is a view showing a structure of a downlink subframe according to an exemplary embodiment of the present invention.

FIG. 4 is a view showing a schematic structure of an apparatus for transmitting downlink control information according to an exemplary embodiment of the present invention.

FIG. 5 is a schematic flowchart showing a method for transmitting downlink control information of a base station in a mobile communication system according to an exemplary embodiment of the present invention.

FIGS. 6A to 6F are views showing examples in which a base station configures an individual control channel region corresponding to each of beams and a shared control channel region in a mobile communication system according to an exemplary embodiment of the present invention.

FIG. 7 is a schematic flowchart showing a method of receiving downlink control information of a terminal in a mobile communication system according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, throughout the specification and the claims, unless explicitly described to the contrary, the word “comprise” and variations such as “comprises” or “comprising” will be understood to imply the inclusion of stated elements but not the exclusion of any other elements.

Throughout the present specification, a terminal may be referred to as a mobile terminal (MT), a mobile station (MS), an advanced mobile station (AMS), a high reliability mobile station (HR-MS), a subscriber station (SS), a portable subscriber station (PSS), an access terminal (AT), user equipment (UE), or the like, and may include all or some of functions of the MT, the MS, the AMS, the HR-MS, the SS, the PSS, the AT, the UE, or the like.

In addition, the base station (BS) may be referred to as an advanced base station (ABS), a high reliability base station (HR-BS), a node B, an evolved node B (eNodeB), an access point (AP), a radio access station (RAS), a base transceiver station (BTS), a mobile multihop relay (MMR)-BS, a relay station (RS) functioning as the base station, a relay node (RN) functioning as the base station, an advanced relay station (ARS) functioning as the base station, a high reliability relay station (HR-RS) functioning as the base station, a small base station [a femto BS, a home node B (HNB), a home eNodeB (HeNB), a pico BS, a metro BS, a micro BS, etc.], etc. and may include all or some of functions of the ABS, the nodeB, the eNodeB, the AP, the RAS, the BTS, the MMR-BS, the RS, the RN, the ARS, the HR-RS, the small base station, or the like.

Hereinafter, a method and apparatus for transmitting downlink control information in a mobile communication system according to an exemplary embodiment of the present invention will be described with reference to the accompanying drawings.

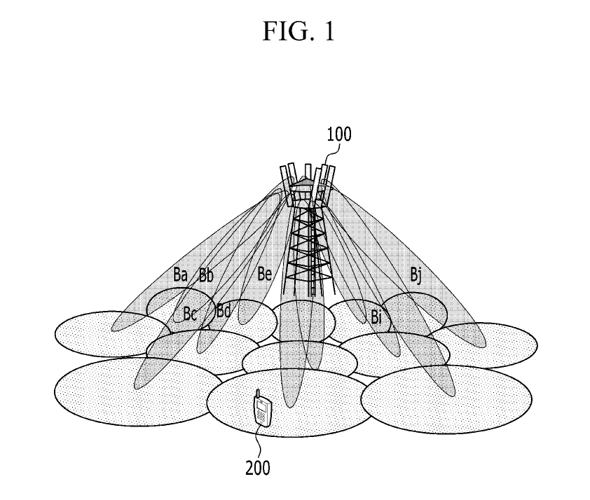

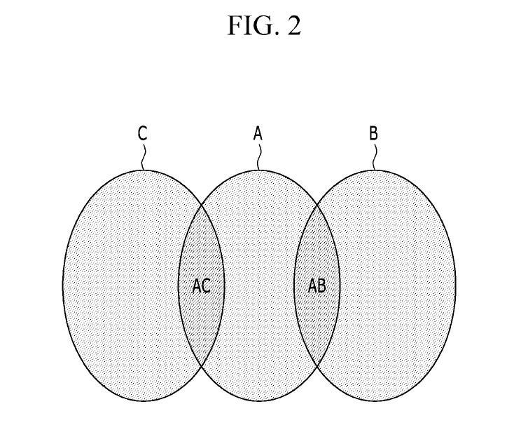

FIG. 1 is a view showing a millimeter-wave-based mobile communication system according to an exemplary embodiment of the present invention. FIG. 2 is a view for describing interference between beams in a case where multiple beams operate in one cell in a mobile communication system according to an exemplary embodiment of the present invention.

Referring to FIG. 1, the millimeter wave based mobile communication system includes a base station 100 and a terminal 200.

The base station 100 performs beam forming and operates a plurality of beams B1˜Bn in one cell. Accordingly, one cell is divided into a plurality of beam regions corresponding to the respective beams B1˜Bn. In this regard, each of the beam regions indicates a region covered by each of beams, i.e. a service coverage of each of the beams B1˜Bn. Each of the plurality of beams B1˜Bn has a unique beam identifier (beam ID), and partially overlaps with a beam having an adjacent service coverage.

The base station 100 uses a millimeter wave frequency bandwidth for communication with the terminal 200. The base station 100 communicates with the terminal 200 by using at least one of the plurality of beams B1˜Bn. The terminal 200 accesses the base station 100 through OFDMA (orthogonal frequency division multiple access).

In a case where the base station 100 operates the plurality of beams B1˜Bn in one cell, since beam regions may partially overlap between adjacent beams, interference between the adjacent beams may occur.

In FIG. 2, for example, a beam region A of the beams operated by the base station 100 partially overlaps with beam regions B and C of adjacent beams, and thus the beam region A may receive interference from the adjacent beams. Interference between the adjacent beams influences data decoding of the terminal 200.

Interference intensity from the adjacent beams may be different according to a location of the terminal 200 in the beam region A. In FIG. 2, for example, the beam region A may be divided into regions AB and AC having strong interference intensity from the adjacent beams, and other regions.

According to an exemplary embodiment of the present invention, a control channel may be configured to enable cooperation communication in regions having strong interference intensity from adjacent beams, and a control channel may be configured to minimize interference between adjacent beams in other regions.

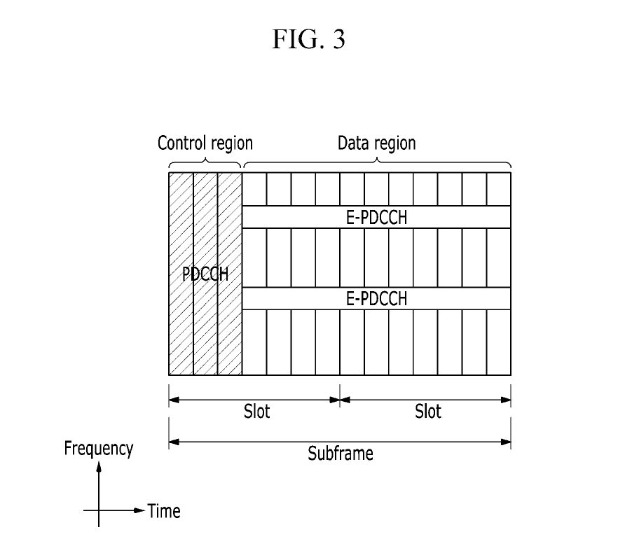

FIG. 3 is a view showing a structure of a downlink subframe according to an exemplary embodiment of the present invention.

A downlink radio frame may be configured as a plurality of subframes.

Referring to FIG. 3, each of the subframes is divided into a control region and a data region in a time domain. Meanwhile, although the control region is illustrated to include a maximum of 3 OFDM (Orthogonal Frequency Division Multiplex) symbols of a first slot in a subframe in FIG. 3, the number of OFDM symbols included in the control region may be changed.

Each of slots includes a plurality of OFDM symbols in the time domain. One OFDN symbol includes a plurality of resource blocks in a frequency domain. A resource block includes a plurality of subcarriers in the frequency domain. An OFDM symbol may be referred to as an OFDMA symbol, an SC-FDMA symbol, etc., according to a multiple access method. The number of OFDM symbols included in one slot may be variously changed according to a channel bandwidth or a length of a CP (Cyclic Prefix). For example, in a normal CP, one slot may include 7 OFDM symbols, whereas in an extended CP, one slot may include 6 OFDM symbols. For convenience of description, FIG. 3 illustrates an example of a subframe configured as one slot including 7 OFDMA symbols.

PDCCHs (Physical Downlink Control CHannels) are allocated to the control region. PDCCHs are physical downlink control channels, and are allocated to a first predetermined number of OFDM symbols of a subframe. PDCCHs may be distributed and disposed in all regions of a system band in consideration of frequency diversity of control channel information. Meanwhile, PCFICHs (Physical Control Format Indicator CHannels), PHICHs (Physical Hybrid automatic retransmit request Indicator CHannels), etc. may be allocated to the control region, in addition to PDCCHs.

PDSCHs (Physical Downlink Shared CHannels) are allocated to the data region. A part of the data region is allocated as an E-PDCCH (Enhanced PDCCH) resource region.

The E-PDCCH is a channel for extending a limited PDCCH capacity. The E-PDCCH may be disposed in consideration of a beam forming gain and interference between adjacent cells, rather than a frequency diversity gain.

The E-PDCCH performs user control information transmission for a terminal connected to a cell. The E-PDCCH may include information for a plurality of terminals so that the terminals that receive the information may necessarily perform a process of searching for and restoring their own user control information from the E-PDCCH.

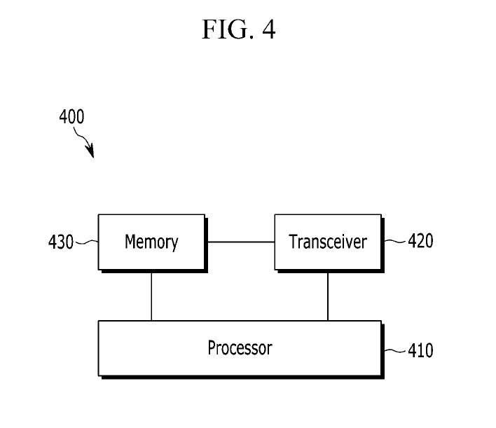

FIG. 4 is a view showing a schematic structure of an apparatus 400 for transmitting downlink control information according to an exemplary embodiment of the present invention.

Referring to FIG. 4, the apparatus 400 for transmitting the downlink control information includes a processor 410, a transceiver 420, and a memory 430. The apparatus 400 for transmitting the downlink control information may be implemented in the base station 100 of a mobile communication system.

The processor 410 controls a general operation of the apparatus 400 for transmitting the downlink control information. The processor 410 may operate a plurality of beams and configure an individual control channel region corresponding to each of the beams and a shared control channel region.

The individual control channel region is a resource region individually allocated to each of the beams. The individual control channel region is configured using the individual control channel regions of adjacent beams and resource regions distributed in a frequency domain or a time domain in order to minimize interference between the adjacent beams.

The shared control channel region is a resource region shared between the adjacent beams. The shared control channel region may be used for cooperation communication between the beams in an interference region between the adjacent beams. That is, the processor 410 allocates the same resource region as the shared control channel region with respect to the adjacent beams and operates the beams to transmit the same data between the adjacent beams through the shared control channel region.

The processor 410 determines a main transmission beam of the terminal 200 based on downlink channel state information received from the terminal 200 or an uplink signal of the terminal 200. If the main transmission beam of the terminal 200 is determined, the processor 410 allocates a control channel of the terminal 200 to the individual control channel region or the shared control channel region of the main transmission beam. For example, in a case where the terminal 200 is located in the interference region between the adjacent beams, the processor 410 may preferentially allocate the control channel of the terminal 200 to the shared control channel region allocated to the main transmission beam. For another example, in a case where the terminal 200 is located at a region having relatively small interference from the adjacent beams, the processor 410 may preferentially allocate the control channel of the terminal 200 to the individual control channel region allocated to the main transmission beam.

If the control channel of the terminal 200 is allocated, the processor 410 controls beam forming of the transceiver 420 such that the user control information of the terminal 200 may be transmitted through the allocated control channel. If the control channel of the terminal 200 is allocated to the individual control channel region, the processor 410 controls beam forming of the transceiver 420 such that the user control information of the terminal 200 may be transmitted through the main transmission beam. If the control channel of the terminal 200 is allocated to the shared control channel region, the processor 410 controls beam forming of the transceiver 420 such that the user control information of the terminal 200 may be transmitted through the plurality of beams that share the shared control channel region.

The transceiver 420 forms multiple beams for communication with the terminal 200, and transmits/receives the control signal and data to/from the terminal 200 by using the multiple beams. The transceiver 420 transmits the user control information of the terminal 200 through the plurality of beams, and periodically receives the downlink channel state information from the terminal 200.

The memory 430 stores instructions that are to be performed by the processor 410, or loads or temporally stores instructions from a storage device (not shown). The processor 410 executes the instructions stored in the memory 430 or the loaded instructions.

The processor 410 and the memory 430 may be connected to each other via a bus (not shown). An input/output interface (not shown) may be connected to the bus. In this regard, the transceiver 420 is connected to the input/output interface, and a peripheral device such as an input device, a display, a speaker, a storage device, etc. may be connected to the input/output interface.

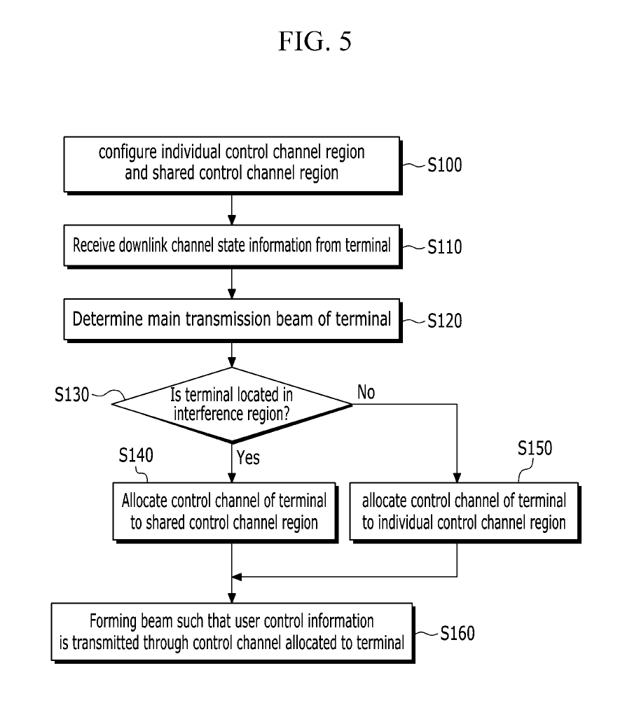

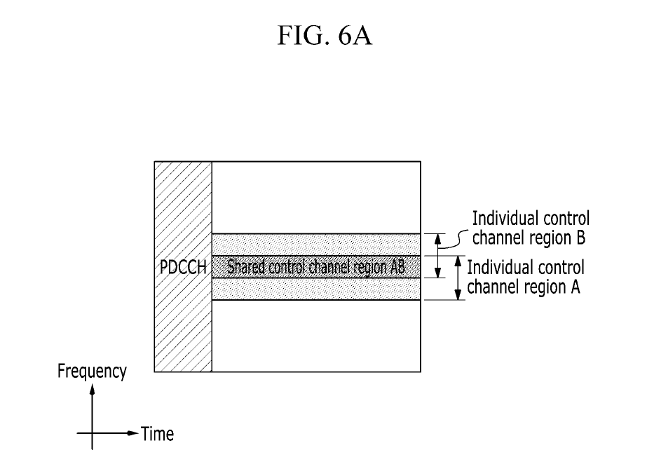

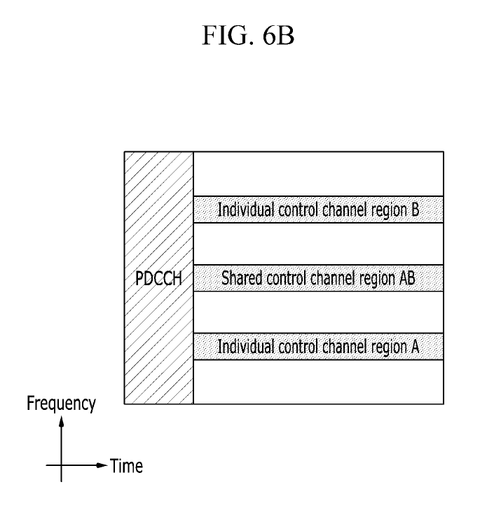

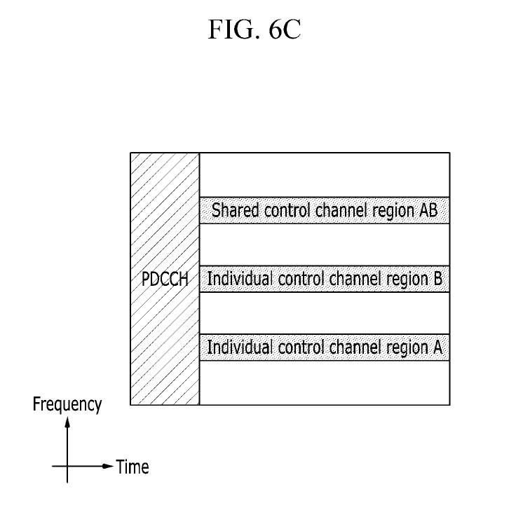

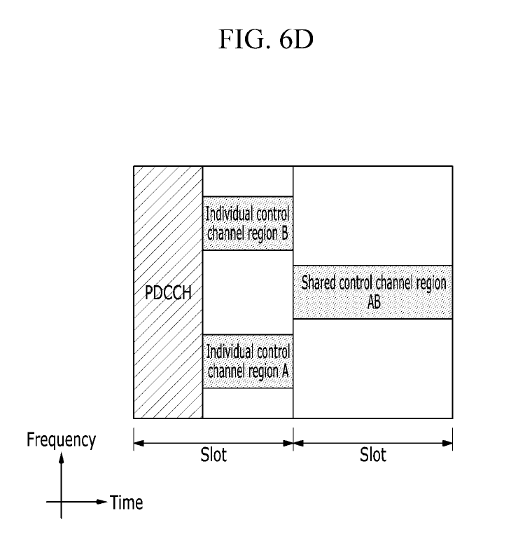

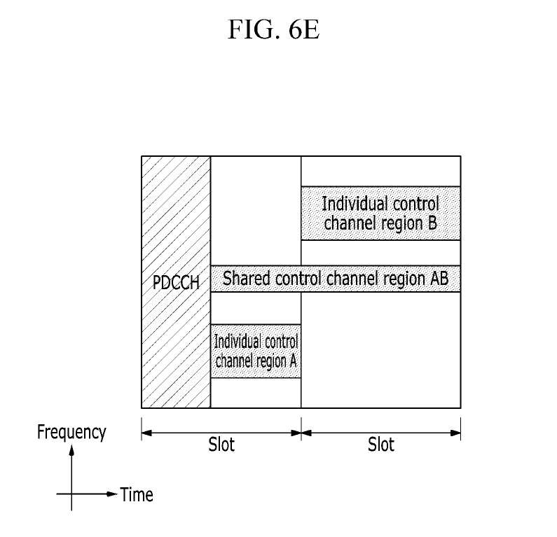

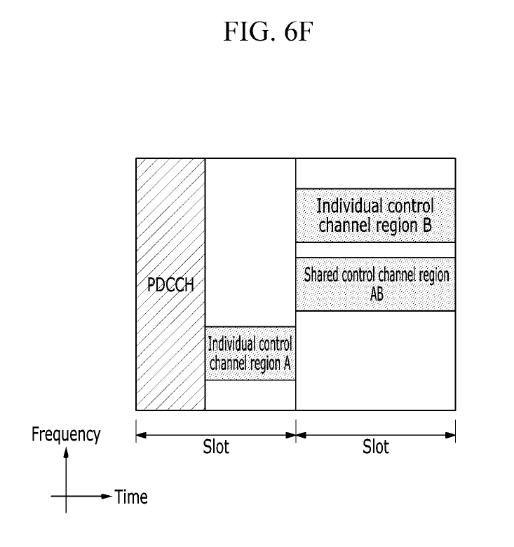

A method for transmitting downlink control information of the apparatus 400 for transmitting the downlink control information according to an exemplary embodiment of the present invention will be described in detail below with reference to FIGS. 5 through 6F.

FIG. 5 is a schematic flowchart showing a method for transmitting downlink control information of the apparatus 400 for transmitting the downlink control information in a mobile communication system according to an exemplary embodiment of the present invention.

Referring to FIG. 5, the apparatus 400 for transmitting the downlink control information in the mobile communication system according to an exemplary embodiment of the present invention configures an individual control channel region corresponding to each of a plurality of beams operating in one cell. A shared control channel region shared with adjacent beams with respect to each of the beams is configured (S100).

FIGS. 6A to 6F are views showing examples in which a base station configures an individual control channel region corresponding to each of beams and a shared control channel region in a mobile communication system according to an exemplary embodiment of the present invention.

The apparatus 400 for transmitting the downlink control information may configure the individual control channel region of each of the beams such that the individual control channel regions between adjacent beams may partially overlap in a frequency domain or a time domain. In this case, the shared control channel region may be allocated to an overlapping region between the individual control channel regions of the adjacent beams.

In FIG. 6A, for example, the apparatus 400 for transmitting the downlink control information allocates individual control channel regions A and B that partially overlap in the frequency domain with adjacent beams A and B. The apparatus 400 for transmitting the downlink control information allocates a shared control channel region AB shared between the beams A and B to an overlapping region of the individual control channel regions A and B.

The apparatus 400 for transmitting the downlink control information may configure the individual control channel regions by allocating resource regions distributed in the frequency domain or the time domain with respect to the adjacent beams in order to minimize interference from the adjacent beams. The apparatus 400 for transmitting the downlink control information may configure the shared control channel region by allocating the distributed resource regions to the individual control channel region corresponding to each of the beams.

In FIGS. 6A and 6C, for example, the apparatus 400 for transmitting the downlink control information configures the individual control channel regions A and B by using resource regions having different frequency bands with respect to the adjacent beams A and B. The apparatus 400 for transmitting the downlink control information allocates the shared control channel region AB shared between the beams A and B to the individual control channel regions A and B by using the resource regions distributed in the frequency domain.

In FIG. 6D, for example, the apparatus 400 for transmitting the downlink control information configures the individual control channel regions A and B by using resource regions having different frequency bands in the same slot with respect to the adjacent beams A and B. The apparatus 400 for transmitting the downlink control information allocates the shared control channel region AB of the beams A and B to a different slot from a slot to which the individual control channel regions A and B are allocated.

In FIG. 6E, for example, the apparatus 400 for transmitting the downlink control information configures the individual control channel regions A and B by using resource regions distributed in the time domain and the frequency domain with respect to the adjacent beams A and B. The apparatus 400 for transmitting the downlink control information configures the shared control channel region AB of the beams A and B by using resource regions having different frequency bands in the same slot as that of the individual control channel region B of the beam B.

In FIG. 6F, for example, the apparatus 400 for transmitting the downlink control information configures the individual control channel regions A and B by using resource regions distributed in the time domain and the frequency domain with respect to the adjacent beams A and B. The apparatus 400 for transmitting the downlink control information configures the shared control channel region AB of the beams A and B by using resource regions having different frequency bands from that of the individual control channel regions A and B in relation to a plurality of slots.

FIGS. 6A through 6F illustrate examples in which the apparatus 400 for transmitting the downlink control information configures the individual control channel regions and the shared control channel region, but the present invention is not limited thereto. A method in which the apparatus 400 for transmitting the downlink control information configures the individual control channel regions and the shared control channel region may be variously modified. For example, although FIGS. 6A through 6F illustrate a case where the apparatus 400 for transmitting the downlink control information configures the individual control channel regions and the shared control channel region of each of beams in the data region (E-PDCCH region) by way of example, the individual control channel regions or the shared control channel region of each of beams may be configured in the control region (PDCCH region).

The apparatus 400 for transmitting the downlink control information may configure the individual control channel regions to include location information with respect to the shared control channel region of each of beams in the individual control channel regions of each of beams. In this case, the terminal 200 may selectively search for only its own shared control channel region without having to search for all shared control channel regions in a case where a control channel of the terminal 200 is not searched in an individual control channel region of a main transmission beam thereof.

The apparatus 400 for transmitting the downlink control information may configure the individual control channel regions to include information (a beam identifier (ID), etc.) regarding adjacent beams in a cooperative relationship with each of beams. In this case, although the terminal 200 does not receive the information regarding the adjacent beams from the base station 100, the terminal 200 may determine the adjacent beams in a cooperative relationship with the main transmission beam thereof.

Referring to FIG. 4, the apparatus 400 for transmitting the downlink control information receives downlink channel state information from the terminal 200 (S110). The downlink channel state information may include, for example, receiving quality (or intensity of a received signal) of each of the beams, beam selection information, interference information between beams, etc. in the terminal 200.

The terminal 200 feeds back the downlink channel state information to the base station 100 during a cell search process. The terminal 200 periodically feeds back the downlink channel state information to the base station 100 after a connection between the terminal 200 and the base station 100 is set.

The apparatus 400 for transmitting the downlink control information determines a main transmission beam of the terminal 200 among a plurality of beams operated by the base station 100 (S120).

In operation S120, the apparatus 400 for transmitting the downlink control information may obtain the receiving quality (or the intensity of the received signal) of each of the beams in the terminal 200 from the downlink channel state information received from the terminal 200 and select the main transmission beam of the terminal 200 based on the receiving quality (or the intensity of the received signal) of each of the beams. For example, the apparatus 400 for transmitting the downlink control information may determine a beam having the best receiving quality in the terminal 200 as the main transmission beam of the terminal 200. In this case, the apparatus 400 for transmitting the downlink control information transmits beam selection information including an identifier (a beam ID) of the beam selected as the main transmission beam of the terminal 200 to the terminal 200, thereby informing the terminal 200 of a main transmission beam of the apparatus 400.

In operation S120, the apparatus 400 for transmitting the downlink control information may obtain the beam selection information of the terminal 200 from the downlink channel state information received from the terminal 200 and determine the main transmission beam of the terminal 200 based on the beam selection information.

In operation S120, the apparatus 400 for transmitting the downlink control information may measure intensity of an uplink signal received from the terminal 200 and determine the main transmission beam of the terminal 200.

If the apparatus 400 for transmitting the downlink control information determines the main transmission beam of the terminal 200, the apparatus 400 for transmitting the downlink control information determines whether the terminal 200 is located in an interference region (S130).

In operation S130, in a case where the downlink channel state information includes the receiving quality (or the intensity of the received signal) of each of the beams, the apparatus 400 for transmitting the downlink control information may determine whether the terminal 200 is located in the interference region based on the receiving quality (or the intensity of the received signal) of each of the beams. For example, if receiving quality (or intensity of a received signal) of an adjacent beam other than the main transmission beam exceeds a preset level, the apparatus 400 for transmitting the downlink control information may determine that the terminal 200 is located in the interference region.

In operation S130, in a case where the downlink channel state information includes the interference information between the beams, the apparatus 400 for transmitting the downlink control information may determine whether the terminal 200 is located in the interference region based on the interference information between the beams.

In operation S130, the apparatus 400 for transmitting the downlink control information may measure the intensity of the uplink signal received from the terminal 200 and determine whether the terminal 200 is located in the interference region based on the intensity of the uplink signal.

In a case where the apparatus 400 for transmitting the downlink control information determines that the terminal 200 is located in the interference region in operation S130, the apparatus 400 for transmitting the downlink control information preferentially allocates a control channel of the terminal 200 to a shared control channel region corresponding to the main transmission beam of the terminal 20 (S140). Meanwhile, in a case where a plurality of adjacent beams generate interference with the main transmission beam of the terminal 200 among the plurality of beams operated by the base station 100, a plurality of shared control channel regions shared with beams adjacent to the main transmission beam may also be configured. In this case, the apparatus 400 for transmitting the downlink control information allocates the control channel of the terminal 200 to the shared control channel region allocated to correspond to the interference region in which the terminal 200 is located among the plurality of shared control channel regions configured to correspond to the main transmission beam of the terminal 200 based on the location information of the terminal 200.

In operation S140, in a case where the apparatus 400 for transmitting the downlink control information determines that the terminal 200 is located in the interference region, if the corresponding shared control channel region has no available resource, the apparatus 400 for transmitting the downlink control information may allocate the control channel of the terminal 200 to the individual control channel region allocated to the main transmission beam.

In operation S130, in a case where the apparatus 400 for transmitting the downlink control information determines that the terminal 200 is located beyond the interference region, the apparatus 400 for transmitting the downlink control information preferentially allocates the control channel of the terminal 200 to the individual control channel region corresponding to the main transmission beam of the terminal 200 (S150).

In operation S150, in a case where the apparatus 400 for transmitting the downlink control information determines that the terminal 200 is not located in the interference region, if the individual control channel region allocated to the main transmission beam has no available resource, the apparatus 400 for transmitting the downlink control information may allocate the control channel of the terminal 200 to the shared control channel region corresponding to the main transmission beam of the terminal 200.

If the control channel of the terminal 200 is completely allocated, the apparatus 400 for transmitting the downlink control information performs beam forming such that user control information of the terminal 200 is transmitted through the control channel allocated to the terminal 200 (S160).

In operation S160, in a case where the control channel of the terminal 200 is allocated to the individual control channel region, the apparatus 400 for transmitting the downlink control information performs beam forming such that the user control information of the terminal 200 is transmitted only using the main transmission beam. For example, in a case where the control channel of the terminal 200 is allocated to the individual control channel region of the beam A, the base station 100 may form the beam A such that the user control information of the terminal 200 is included in the individual control channel region A of the beam A.

In operation S160, in a case where the control channel of the terminal 200 is allocated to the shared control channel region, the apparatus 400 for transmitting the downlink control information performs beam forming such that the user control information of the terminal 200 is included not only in the main transmission beam of the terminal 200, but also in adjacent beams that share the shared control channel with the main transmission beam. For example, in a case where the control channel of the terminal 200 is allocated to the shared control channel region AB of the beam A that is the main transmission beam and the adjacent beam B, the apparatus 400 for transmitting the downlink control information may form the beams A and B such that the user control information of the terminal 200 is included in the shared control channel region AB of the beams A and B. That is, both the beams A and B may be formed to transmit the user control information of the terminal 200 in the control channel allocated to the terminal 200.

Meanwhile, a case where one of the individual control channel region and the shared control channel region is selected according to whether the terminal 200 is located in the interference region and the control channel of the terminal 200 and is allocated to the selected control channel region is illustrated in FIG. 5 above by way of example, but the present invention is not limited thereto. The apparatus 400 for transmitting the downlink control information may select one of the individual control channel region and the shared control channel region according to available resources irrespective of whether the terminal 200 is located in the interference region and allocate the control channel of the terminal 200.

In a case where there is no terminal requiring cooperative communication (terminal located in an interference region between beams), the apparatus 400 for transmitting the downlink control information may allocate and use a resource region allocated as the shared control channel region as the individual control channel region of a corresponding beam. As described above, in a case where the shared control channel region is selectively configured, the apparatus 400 for transmitting the downlink control information may include information indicating whether the shared control channel region is present in the individual control channel region, thereby allowing the terminal 200 to not perform an unnecessary control channel search.

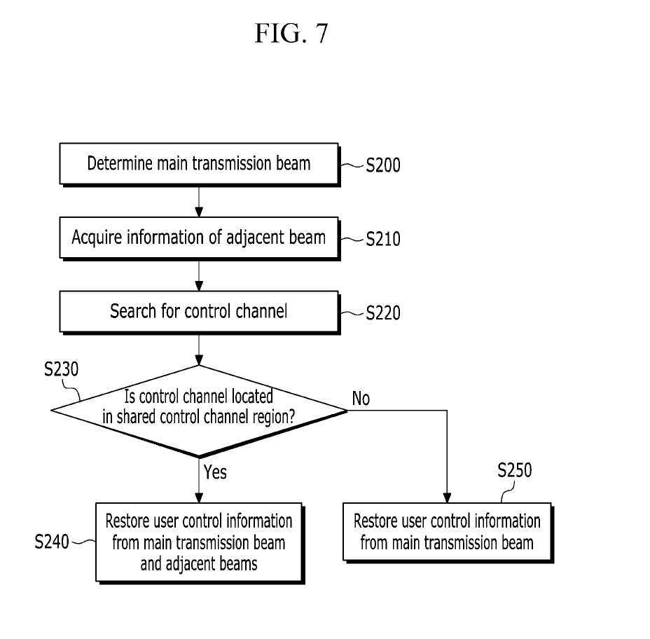

FIG. 7 is a schematic flowchart showing a method of receiving downlink control information of the terminal 200 in a mobile communication system according to an exemplary embodiment of the present invention.

Referring to FIG. 7, the terminal 200 determines a main transmission beam of the terminal 200 among a plurality of beams operated by the base station 100 in the mobile communication system according to an exemplary embodiment of the present invention (S200).

In operation S200, the terminal 200 may measure receiving quality (or intensity of a received signal) of each of beams received from the base station 100, and select a beam having the best receiving quality as a main transmission beam of the terminal 200. In this case, the terminal 200 transmits downlink channel state information including beam selection information including an identifier (a beam ID) of the main transmission beam selected by the terminal 200 to the base station 100, thereby informing the base station 100 of the main transmission beam thereof.

In operation S200, the terminal 200 may receive information regarding the main transmission beam thereof from the base station 100. In this case, the terminal 200 may transmit the downlink channel state information including the receiving signal quality (or the intensity of the received signal) of each of beams received in the terminal 200 to the base station 100, and receive information regarding the main transmission beam determined by the base station 100 based on the downlink channel state information.

The terminal 200 obtains information regarding adjacent beams that generate interference with the main transmission beam (S210) if the main transmission beam thereof is selected.

In operation S210, the terminal 200 may directly receive the information regarding the adjacent beams from the base station 100. In this case, the base station 100 may select at least one adjacent beam that generates interference with the main transmission beam of the terminal 200 from among the plurality of beams operated based on a location of the main transmission beam of the terminal 200, and transmit information regarding the selected adjacent beam to the terminal 200.

In operation S210, the terminal 200 may receive beam information including a beam identifier (beam ID) of each of the beams operated by the base station 100, location information, information regarding adjacent beams, etc., from the base station 100, and obtain information regarding an adjacent beam corresponding to the main transmission beam thereof from the beam information.

Meanwhile, in a case where an individual control channel region allocated to each of the beams includes information regarding adjacent beams that perform cooperative communication with each of the beams, since the terminal 200 does not necessarily receive the information regarding adjacent beams from the base station 100, operation S210 may be omitted.

That is, if the main transmission beam and the adjacent beams are determined, the terminal 200 receives at least one beam from the base station 100, and searches for a control channel allocated to the terminal 200 from the at least one received beam (S220).

In operation S220, the terminal 200 may sequentially search for the individual control channel regions and the shared control channel regions that are allocated to the beams in order to search for the control channel allocated to the terminal 200.

In operation S220, the terminal 200 may selectively search for the individual control channel region and the shared control channel region that are allocated to the main transmission beam based on the beam identifier (beam ID) of the main transmission beam and search for the control channel thereof. In this case, the individual control channel region of each of the beams may include location information of the shared control channel region of each of the beams. The terminal 200 may decode the location information of the shared control channel region of each of the beams in the individual control channel region of each of the beams and determine a location of the shared control channel region of each of the beams.

In operation S220, in a case where the control channel of the terminal 200 is allocated to the shared control channel region of the main transmission beam (S240), the terminal 200 decodes user control information thereof not only from the main transmission beam thereof but also from adjacent beams that share the corresponding shared control channel region (S250). That is, in a case where the control channel of the terminal 200 is allocated to the shared control channel region, the terminal 200 decodes the user control information transmitted from the main transmission beam and the adjacent beams through the control channel allocated to the terminal 200. In this case, the terminal 200 receives the same user control information through a plurality of beams, thereby improving transmission performance.

In a case where the control channel of the terminal 200 is allocated to the individual control channel region of the main transmission beam (S240), the terminal 200 decodes the user control information thereof from the main transmission beam thereof (S260). That is, in a case where the control channel of the terminal 200 is allocated to the individual control channel region of the main transmission beam, the terminal 200 decodes the user control information transmitted from the main transmission beam thereof through the control channel allocated to the terminal 200.

According to an exemplary embodiment of the present invention, a base station configures an individual control channel region by using distributed resource regions with respect to each of beams, thereby avoiding interference from adjacent beams with respect to a control channel. The base station also configures a shared control channel region shared between adjacent beams and used to transmit the same data, separately from the individual control channel region, thereby enabling cooperative communication between the adjacent beams, and thus transmission performance of a control channel may also be improved.

The exemplary embodiments of the present invention described above are not implemented through only the apparatus and/or the method described above, but may also be implemented through programs executing functions corresponding to configurations of the exemplary embodiments of the present invention, a recording medium in which the programs are recorded, and the like. In addition, these implementations may be easily made by those skilled in the art to which the present invention pertains from the exemplary embodiments described above.

What is claimed is:

1. A method for transmitting downlink control information in a base station that operates a plurality of beams in one cell, the method comprising:
configuring an individual control channel region allocated to each of the plurality of beams;
configuring a shared control channel region shared with first and second beams that are adjacent to each other among the plurality of beams;
allocating a control channel of a terminal positioned in a service coverage of the first beam to one of the individual control channel region of the first beam and the shared control channel region shared with the first and second beams; and
in a case where the control channel of the terminal is allocated to the shared control channel region shared with the first and second beams, forming the first and second beams such that user control information of the terminal is transmitted through the shared control channel region shared with the first and second beams.

2. The method of claim 1, further comprising,
in a case where the control channel of the terminal is allocated to the individual control channel region of the first beam, forming the first beam such that user control information of the terminal is transmitted through the individual control channel region of the first beam.

3. The method of claim 1, wherein
the individual control channel region allocated to each of the plurality of beams is configured by using resource regions distributed in a frequency domain or a time domain.

4. The method of claim 3, wherein
the shared control channel region and an individual control channel region allocated to the first beam and the second beam are configured by using resource regions distributed in the frequency domain or the time domain.

5. The method of claim 1, wherein
an individual control channel region of each of the first beam and the second beam is configured by using resource regions partially overlapping in a frequency domain or a time domain, and
the shared control channel region shared with the first and second beams is configured as a resource region overlapping between an individual control channel region of the first beam and an individual control channel region of the second beam.

6. The method of claim 1, wherein
the allocating includes,
in a case where interference intensity of the second beam with respect to the terminal exceeds a threshold, allocating the control channel of the terminal to the shared control channel region shared with the first and second beams.

7. The method of claim 1, wherein
the allocating includes,
in a case where interference intensity of the second beam with respect to the terminal is below a threshold, allocating the control channel of the terminal to the individual control channel region of the first beam.

8. The method of claim 1, wherein
location information of the shared control channel region shared with the first and second beams is included in the individual control channel region of the first beam.

9. The method of claim 1, wherein
beam information of the second beam is included in the individual control channel region of the first beam.

10. The method of claim 1, further comprising
transmitting beam information of the second beam to the terminal.

11. A method for transmitting downlink control information in a base station that operates a plurality of beams in one cell, the method comprising:
configuring an individual control channel region allocated to each of the plurality of beams;
configuring a shared control channel region shared with beams adjacent to each of the plurality of beams;
determining a first beam among the plurality of beams as a main transmission beam of a terminal;
acquiring interference intensity of a second beam adjacent to the first beam with respect to the terminal;
in a case where the interference intensity exceeds a threshold, preferentially allocating a control channel of the terminal to the shared control channel region of the first and second beams; and
when the control channel of the terminal is allocated to the shared control channel region of the first and second beams, forming the first and second beams such that user control information of the terminal is transmitted through the shared control channel region of the first and second beams.

12. The method of claim 11, further comprising
receiving downlink channel state information from the terminal,
wherein the determining includes
determining the first beam among the plurality of beams as the main transmission beam of the terminal based on the downlink channel state information.

13. The method of claim 11, further comprising
measuring signal intensity of an uplink signal received from the terminal,
wherein the determining includes
determining the first beam among the plurality of beams as the main transmission beam of the terminal based on the signal intensity of the uplink signal.

14. An apparatus for transmitting downlink control information in a mobile communication system that operates a plurality of beams in one cell, the apparatus comprising:
a transceiver transmitting/receiving the plurality of beams including first and second beams that are adjacent to each other; and
a processor configuring an individual control channel region allocated to each of the plurality of beams and a shared control channel region shared with first and second beams that are adjacent to each other among the plurality of beams, allocating a control channel of a terminal positioned in a service coverage of the first beam to one of an individual control channel region of the first beam and the shared control channel region shared with the first and second beams, and in a case where the control channel of the terminal is allocated to the shared control channel region shared with the first and second beams, forming the first and second beams such that user control information of the terminal is transmitted through the shared control channel region shared with the first and second beams.

15. The apparatus of claim 14, wherein,
in a case where the control channel of the terminal is allocated to the individual control channel region of the first beam, the processor forms the first beam such that user control information of the terminal is transmitted through the individual control channel region of the first beam.

16. The apparatus of claim 14, wherein
the individual control channel region allocated to each of the plurality of beams is configured by using resource regions distributed in a frequency domain or a time domain, and
the shared control channel region shared with the first and second beams and an individual control channel region allocated to the first beam and the second beam are configured by using the resource regions distributed in the frequency domain or the time domain.

17. The apparatus of claim 14, wherein
the individual control channel region of each of the first beam and the second beam is configured by using resource regions partially overlapping in a frequency domain or a time domain, and
the shared control channel region shared with the first and second beams is configured as a resource region overlapping between the individual control channel region of the first beam and the individual control channel region of the second beam.

18. The apparatus of claim 14, wherein,
in a case where interference intensity of the second beam with respect to the terminal exceeds a threshold, the processor allocates the control channel of the terminal to the shared control channel region shared with the first and second beams.

19. The apparatus of claim 14, wherein,
in a case where interference intensity of the second beam with respect to the terminal is below a threshold, the processor allocates the control channel of the terminal to the individual control channel region of the first beam.

20. The apparatus of claim 14, wherein
the processor configures the individual control channel region of the first beam to include location information of the shared control channel region shared with the first and second beams or beam information of the second beam.
